(19) United States
(12) Patent Application Publication
(10) Pub. No.: US 2015/0097760 A1
(43) Pub. Date: Apr. 9, 2015

(54) DISPLAY APPARATUS AND ARRAY DISPLAY PANEL THEREOF

(71) Applicant: Shenzhen China Star Optoelectronics Technology Co. Ltd., Shenzhen, Guangdong (CN)

(72) Inventor: Chengliang Ye, Shenzhen (CN)

(73) Assignee: Shenzhen China Star Optoelectronics Technology Co. Ltd., Shenzhen, Guangdong (CN)

(21) Appl. No.: 14/129,993

(22) PCT Filed: Nov. 7, 2013
(86) PCT No.: PCT/CN2013/086675

§ 371 Date: Dec. 30, 2013

(30) Foreign Application Priority Data
Oct. 9, 2013 (CN) 201310468342.1

(51) Int. Cl. G09G 3/00

(52) U.S. Cl. CPC G09G 3/003; G09G 2300/0447
USPC 345/32

(57) ABSTRACT

A display apparatus and an array display panel thereof are disclosed. The array display panel has a phase retarder film and a plurality of pixel rows. Each of the pixel rows includes first sub-pixels and second sub-pixels. Each first sub-pixel has a first major section and a first minor section which are arranged in a first direction; each second sub-pixel has a second major section and a second minor section which are arranged in the direction opposite the first direction. The apparatus can effectively improve the problem of asymmetric crosstalk.

### BACKGROUND OF THE INVENTION

1. Field of the Invention

The present invention relates to the field of display apparatus, especially to a display apparatus and an array display panel thereof.

2. Description of the Related Art

A conventional display panel that uses an FPR (Film-type Patterned Retarder) 3D technology includes a phase retarder film, which has a plurality of phase retardation regions that correspond to the positions of the pixel rows. The phase retarder film is used to produce different phase delays for sections of an image, so as to turn those sections of the image into a corresponding left-eye image and a corresponding right-eye image on 3D glasses.

A conventional display panel using the FPR 3D technology may have a plurality of pixel rows. As shown in FIG. 1, each of the pixel rows includes a plurality of sub-pixels 120, and each of the sub-pixels 120 has an upper section 121 and a lower section 122. The display panel may further have TFTs (Thin Film Transistors), scanning lines, data lines, and so forth, which are not shown in FIG. 1.

During the implementation of the conventional technology, it is found that the conventional technology has at least has the following problem:

As shown in FIG. 1, there is a phenomenon in the conventional display panel using FPR 3D technology that the extent of light leak at a lower viewing angle and the extent of light leak at a higher viewing angle are different, which leads to asymmetric crosstalk.

Hence, it is necessary to provide a new technical solution to overcome the problems existing in the conventional technology.

### SUMMARY OF THE INVENTION

An objective of the present invention is to provide a display apparatus and an array display panel thereof, which can compensate for the non-uniformity of the light leak occurring in the areas where the left-eye and right-eye images correspond, thereby effectively improving the problem of asymmetric (non-uniform) crosstalk under wide viewing angles.

In order to achieve the foregoing object, the present invention provides a display apparatus having an array display panel, a data-line driving circuit, a scan-line driving circuit and a power source, wherein the array display panel includes a phase retarder film and at least two pixel rows, wherein each of the pixel rows includes at least one first sub-pixel set and at least one second sub-pixel set, wherein the first sub-pixel set includes at least one first sub-pixel, wherein the first sub-pixel has a first major section and a first minor section which are arranged in a first direction; the second sub-pixel set has at least one second sub-pixel, wherein the second sub-pixel has a second major section and a second minor section which are arranged in the direction opposite the first direction; wherein the first sub-pixel set and the second sub-pixel set are adjacent to each other; the first sub-pixel set and the second sub-pixel set are arranged in an order from first to last repeatedly in each of the pixel rows; the number of the first sub-pixels of the first sub-pixel set is equal to the number of the second sub-pixels of the second sub-pixel set.

In one embodiment of the display device, each two adjacent first sub-pixels in a column are identical in being in a first arrangement manner, and each two adjacent second sub-pixels in another column are identical in being in a second arrangement manner, wherein the first arrangement manner is defined as the direction in which the first major section and the first minor section are arranged, and the second arrangement manner is the direction in which the second major section and the second minor section are arranged.

In one embodiment of the display device, the number of the first sub-pixels of the first sub-pixel set is greater than or equal to two; and the number of the second sub-pixels of the second sub-pixel set is greater than or equal to two.

In one embodiment of the display device, the first sub-pixel set has three first sub-pixels, and the second sub-pixel set has three second sub-pixels; the three first sub-pixels are arranged side by side, and the three second sub-pixels are arranged side by side. The first major sections of the three first sub-pixels are oriented in the first direction, and the second major sections of the three second sub-pixels are oriented in the direction opposite the first direction.

The present invention further provides a display apparatus having an array display panel, a data-line driving circuit, a scan-line driving circuit, and a power source, wherein the array display panel includes a phase retarder film and further includes at least two pixel rows, wherein each of the pixel rows has at least one first sub-pixel set and at least one second sub-pixel set, wherein the first sub-pixel set includes at least one first sub-pixel, wherein the first sub-pixel has a first major section and a first minor section which are arranged in a first direction; the second sub-pixel set has at least one second sub-pixel, wherein the second sub-pixel has a second major section and a second minor section which are arranged in the direction opposite the first direction; wherein the first sub-pixel set and the second sub-pixel set are adjacent to each other.

In one embodiment of the display device, the first sub-pixel set and the second sub-pixel set are arranged in an order from first to last repeatedly in each of the pixel rows.

In one embodiment of the display device, the second sub-pixel set and the first sub-pixel set are arranged in an order from first to last repeatedly in each of the pixel rows.

In one embodiment of the display device, each two adjacent first sub-pixels in a column are identical in being in a first arrangement manner, and each two adjacent second sub-pixels in another column are identical in being in a second arrangement manner, wherein the first arrangement manner is the direction in which the first major section and the first minor section are arranged, and the second arrangement manner is defined as the direction in which the second major section and the second minor section are arranged.

In one embodiment of the display device, the number of the first sub-pixels of the first sub-pixel set is equal to the number of the second sub-pixels of the second sub-pixel set.

In one embodiment of the display device, the number of the first sub-pixels of the first sub-pixel set is greater than or equal to two; and the number of the second sub-pixels of the second sub-pixel set is greater than or equal to two.

In one embodiment of the display device, the first sub-pixel set has three first sub-pixels, and the second sub-pixel set has three second sub-pixels; the three first sub-pixels are arranged side by side, and the three second sub-pixels are arranged side by side.

In one embodiment of the display device, the first major sections of the three first sub-pixels are oriented in the first direction, and the second major sections of the three second sub-pixels are oriented in the direction opposite the first direction.

The present invention further provides an array display panel having a phase retarder film and at least two pixel rows, wherein each of the pixel rows has at least one first sub-pixel set and at least one second sub-pixel set, wherein the first sub-pixel set includes at least one first sub-pixel, wherein the first sub-pixel has a first major section and a first minor section which are arranged in a first direction; the second sub-pixel set has at least one second sub-pixel, wherein the second sub-pixel has a second major section and a second minor section which are arranged in the direction opposite the first direction; wherein the first sub-pixel set and the second sub-pixel set are adjacent to each other.

In one embodiment of the array display panel, the first sub-pixel set and the second sub-pixel set are arranged in an order from first to last repeatedly in each of the pixel rows.

In one embodiment of the array display panel, the second sub-pixel set and the first sub-pixel set are arranged in an order from first to last repeatedly in each of the pixel rows.

In one embodiment of the array display panel, each two adjacent first sub-pixels in a column are identical in being in a first arrangement manner, and each two adjacent second sub-pixels in another column are identical in being in a second arrangement manner, wherein the first arrangement manner is defined as the direction in which the first major section and the first minor section are arranged, and the second arrangement manner is defined as the direction in which the second major section and the second minor section are arranged.

In one embodiment of the array display panel, the number of the first sub-pixels of the first sub-pixel set is equal to the number of the second sub-pixels of the second sub-pixel set.

In one embodiment of the array display panel, the number of the first sub-pixels of the first sub-pixel set is greater than or equal to two; and the number of the second sub-pixels of the second sub-pixel set is greater than or equal to two.

In one embodiment of the array display panel, the first sub-pixel set has three first sub-pixels, and the second sub-pixel set has three second sub-pixels; the three first sub-pixels are arranged side by side, and the three second sub-pixels are arranged side by side.

In one embodiment of the array display panel, the first major sections of the three first sub-pixels are oriented in the first direction, and the second major sections of the three second sub-pixels are oriented in the direction opposite the first direction.

Compared to the aforementioned conventional technology, the present invention can compensate for the non-uniformity of the light leak occurring in the areas where the left-eye and right-eye images correspond, thereby effectively improving the problem of asymmetric (non-uniform) crosstalk under wide viewing angles.

In order to make the contents of the present invention more easily understood, the preferred embodiments of the present invention are described in detail in cooperation with accompanying drawings as follows:

### BRIEF DESCRIPTION OF THE DRAWINGS

FIG. 1 is a schematic view of a conventional array display panel;

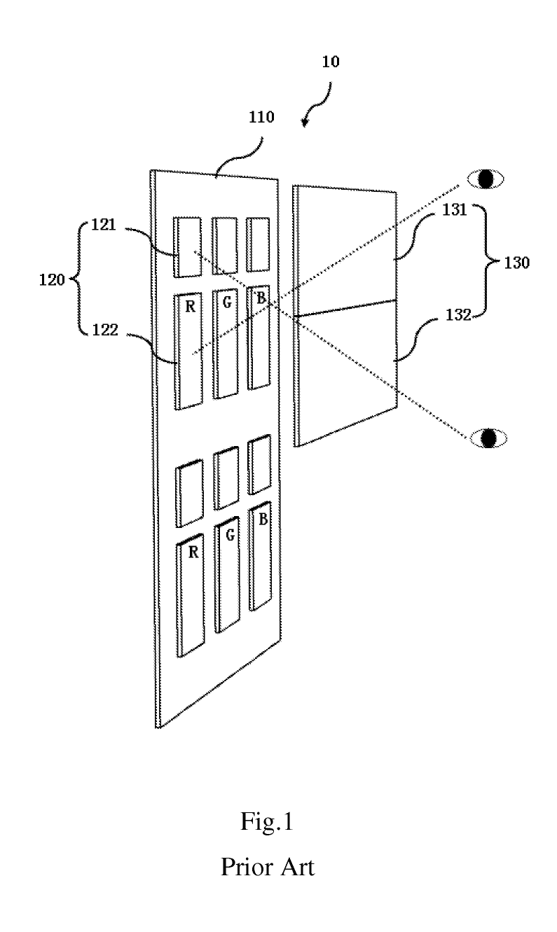

FIG. 2 is a schematic partial view of an array display panel according to the first embodiment of the present invention;

FIG. 3 is a schematic partial view of the array display panel according to the second embodiment of the present invention; and

FIG. 4 is a schematic partial view of the array display panel according to the third embodiment of the present invention.

### DETAILED DESCRIPTION OF THE PREFERRED EMBODIMENTS

The following description of each embodiment is referring to the accompanying drawings so as to illustrate practicable specific embodiments in accordance with the present invention. The directional terms described in the present invention, such as upper, lower, front, rear, left, right, inner, outer, side, etc., are only directions referring to the accompanying drawings, so that the used directional terms are used to describe and understand the present invention, but the present invention is not limited thereto.

The term “array display panel” is referring to a display panel which has a plurality of pixel units arranged in a matrix and may be a TFT-LCD (Thin Film Transistor Liquid Crystal Display) panel, an OLED (Organic Light Emitting Diode) panel, and so forth.

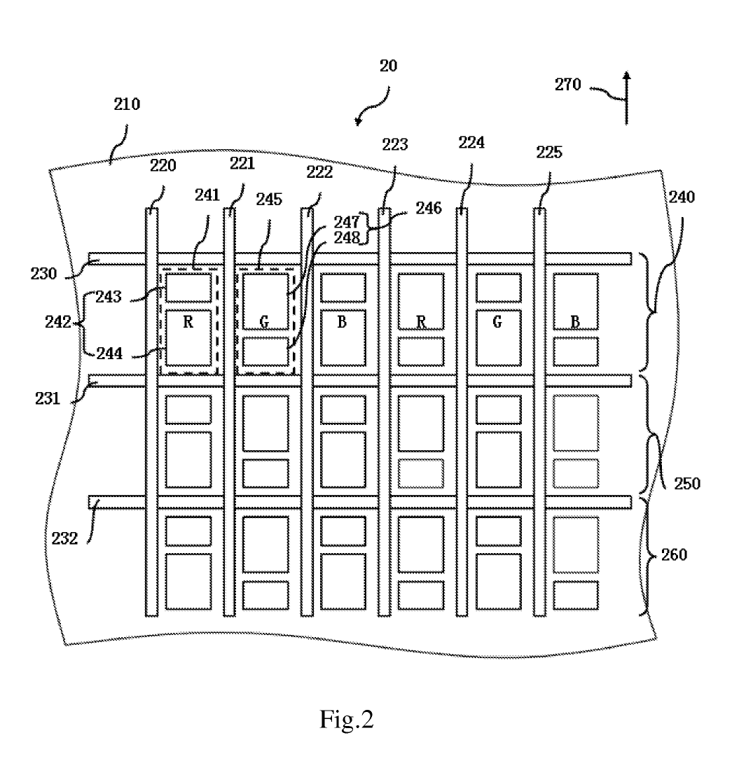

A display apparatus of an embodiment in accordance with the present invention comprises an array display panel 20 (as shown in FIG. 2), a data-line driving circuit (not shown), a scan-line driving circuit (not shown), and a power source (not shown). In the display apparatus, the data-line driving circuit is used to provide data driving signals to the array display panel 20, the scan-line driving circuit is used to provide scanning driving signals to the array display panel, and the power source is used to provide electric power to the data-line driving circuit, the scan-line driving circuit and the array display panel 20. The following is a detailed description of the array display panel 20.

With reference to FIG. 2, FIG. 2 is a schematic partial view of an array display panel according to the first embodiment of the present invention.

The array display panel 20 of the present embodiment comprises a phase retarder film (not shown in the drawings), at least two pixel rows (such as pixel row 240, 250, and 260), at least two data lines (such as data-line 220, 221, 222, 223, 224, and 225), at least two scan lines (such as scan line 230, 231, and 232), and a plurality of thin-film transistors (not shown in the drawings). Each of the pixel rows, such as the pixel row 240, is disposed between two adjacent ones of the scan lines (also called “gate lines”), such as the scan lines 230 and 231, wherein the pixel row 240 includes at least one first sub-pixel set 241 and at least one second sub-pixel set 244.

The first sub-pixel set 241 includes at least one first sub-pixel 242. The first sub-pixel 242 has a first major section 243 and a first minor section 244. The first major section 243 and the first minor section 244 of the first sub-pixel 242 are arranged in the first direction 270, or in other words, the first sub-pixel 242 is oriented in the first direction 270. The second sub-pixel set 245 includes at least one second sub-pixel 246. The second sub-pixel 246 has a second major section 248 and a second minor section 247. The second major section 248 and the second minor section 247 of the second sub-pixel 246 are arranged in the direction opposite the first direction 270, or in other words, the second sub-pixel 246 is oriented in the direction opposite the first direction 270. In this embodiment, the first sub-pixel set 241 and the second sub-pixel set 245 are adjacent to each other, or in other words, the first sub-pixel set 241 and the second sub-pixel set 245 are close to each other, and there are no other sub-pixels between them.

In the array display panel 20 of the present embodiment, the first sub-pixel set 241 and the second sub-pixel set 245 are arranged in an order from first to last repeatedly in each of the pixel rows 240, or in other words, as shown in FIG. 2, in the same pixel row 240, the plurality of first sub-pixel sets 241 (at least two) and the plurality of second sub-pixel sets 245 (at least two) are arranged in the following order: first sub-pixel set, second sub-pixel set, first sub-pixel set, second sub-pixel set, . . . , and so on. In this embodiment, since each first sub-pixel set 241 includes only one first sub-pixel 242, and each second sub-pixel set 245 includes only one second sub-pixel 246, therefore the first sub-pixels 242 and the second sub-pixels 246 in the pixel row 240 are arranged in the following order: first sub-pixel, second sub-pixel, first sub-pixel, second sub-pixel, . . . , and so on.

As for the above-mentioned technical solution, an alternative may be implemented as follows:

The second sub-pixel set 245 and the first sub-pixel set 241 are arranged in an order from first to last repeatedly in each of the pixel rows. That is to say, the order of the first sub-pixel set 241 and the second sub-pixel set 245 in this embodiment is different from the aforementioned one.

In the array display panel 20 of the present embodiment, each two adjacent first sub-pixels in a column are identical in being in a first arrangement manner, and each two adjacent second sub-pixels in another column are identical in being in a second arrangement manner.

The first arrangement manner is defined as the direction in which the first major section and the first minor section are arranged, and the second arrangement manner is defined as the direction in which the second major section and the second minor section are arranged.

As shown in FIG. 2, the pixel row 240 and the pixel row 250 are two adjacent pixel rows, wherein two of the first sub-pixels which are arranged in a column are all oriented in the first direction 270, and two of the second sub-pixels which are arranged in another column are all oriented in the direction opposite the first direction 270.

In the array display panel 20 of the present embodiment, the number of the first sub-pixels 242 of the first sub-pixel set 241 is equal to the number of the second sub-pixels 245 of the second sub-pixel set 245. As shown in FIG. 2, in this embodiment, the number of the first sub-pixel 242 of the first sub-pixel set 241 and the number of the second sub-pixel 246 of the second sub-pixel set 245 are all one.

With the foregoing technical solution being implemented, since the two adjacent first sub-pixel set 241 and second sub-pixel set 245 are oriented in opposite directions, and are arranged in such an order repeatedly, the non-uniformity of the light leak occurring in the areas to which left-eye and right-eye images correspond can be compensated for, and then the problem of asymmetric (non-uniform) crosstalk under wide viewing angles can be effectively improved.

In order to avoid periodic visual bright/dark spots from occurring, the number of the first sub-pixels 242 of the first sub-pixel set 241 is preferably greater than or equal to two; and the number of the second sub-pixels 246 of the second sub-pixel set 245 is also preferably greater than or equal to two.

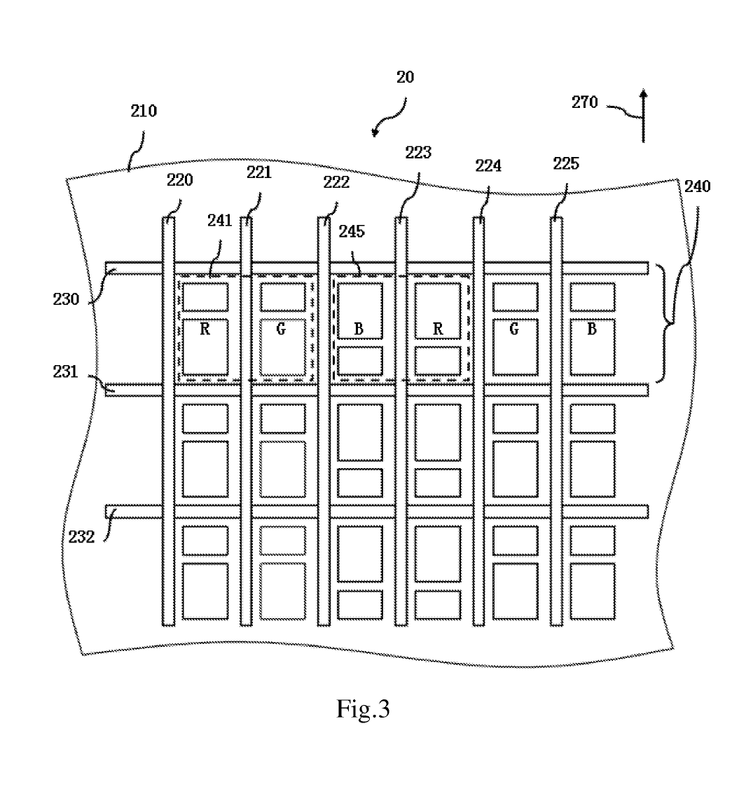

With further reference to FIG. 3, FIG. 3 is a schematic partial view of the array display panel 20 according to a second embodiment in accordance with the present invention. This embodiment is similar to the foregoing first embodiment, but differs in that:

In this second embodiment, a first sub-pixel set 241 includes two first sub-pixels which are adjacent to each other, or in other words, the two first sub-pixels are arranged side by side, and the two first sub-pixels are oriented in the first direction 270; and a second sub-pixel set 245 includes two second sub-pixels which are adjacent to each other, or in other words, the two second sub-pixels are arranged side by side, and the two second sub-pixels are oriented in the direction opposite the first direction 270.

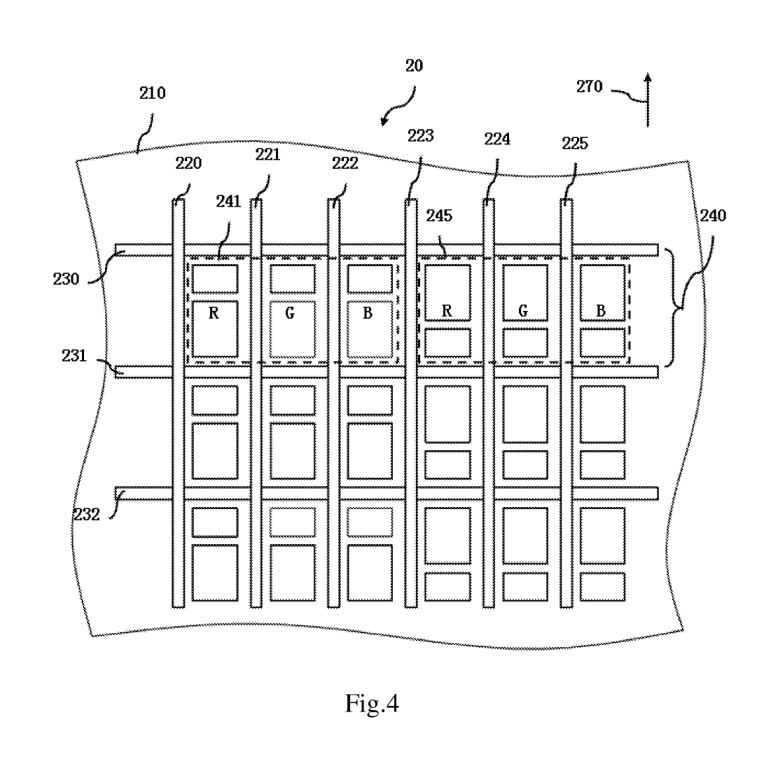

With further reference to FIG. 4, FIG. 4 is a schematic partial view of the array display panel according to a third embodiment in accordance with the present invention. This embodiment is similar to the foregoing first and second embodiments, but differs in that:

In this third embodiment, the first sub-pixel set 241 has three first sub-pixels which are arranged side by side and oriented in the first direction 270; and the second sub-pixel set 245 has three second sub-pixels which are arranged side by side and oriented in the direction opposite the first direction 270.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A display apparatus comprising an array display panel, a data-line driving circuit, a scan-line driving circuit and a power source, wherein the array display panel has:
a phase retarder film; and
at least two pixel rows, wherein each of the pixel rows includes:
at least one first sub-pixel set including at least one first sub-pixel, wherein the first sub-pixel has a first major section and a first minor section which are arranged in a first direction; and
at least one second sub-pixel set including at least one second sub-pixel, wherein the second sub-pixel has a second major section and a second minor section which are arranged in the direction opposite the first direction; wherein
the first sub-pixel set and the second sub-pixel set are adjacent to each other;
the first sub-pixel set and the second sub-pixel set are arranged in an order from first to last repeatedly in each of the pixel rows; and
the number of the first sub-pixels of the first sub-pixel set is equal to the number of the second sub-pixels of the second sub-pixel set.

2. The display apparatus as claimed in claim 1, wherein each two adjacent first sub-pixels in the same pixel row are identical in being in a first arrangement manner, and each two adjacent second sub-pixels in the same pixel row are identical in being in a second arrangement manner, wherein the first arrangement manner is defined as the direction in which the first major section and the first minor section are arranged, and the second arrangement manner is the direction in which the second major section and the second minor section are arranged.

3. The display apparatus as claimed in claim 1, wherein the number of the first sub-pixels of the first sub-pixel set is greater than or equal to two; and the number of the second sub-pixels of the second sub-pixel set is greater than or equal to two.

4. The display apparatus as claimed in claim 3, wherein the first sub-pixel set has three first sub-pixels, and the second sub-pixel set has three second sub-pixels; the three first sub-pixels are arranged side by side, and the three second sub-pixels are arranged side by side; the first major sections of the three first sub-pixels are oriented in the first direction, and the second major sections of the three second sub-pixels are oriented in the direction opposite the first direction.

5. A display apparatus comprising an array display panel, a data-line driving circuit, a scan-line driving circuit and a power source, wherein the array display panel has:
a phase retarder film; and
at least two pixel rows, wherein each of the pixel rows includes:
at least one first sub-pixel set including at least one first sub-pixel, wherein the first sub-pixel has a first major section and a first minor section which are arranged in a first direction; and
at least one second sub-pixel set including at least one second sub-pixel, wherein the second sub-pixel has a second major section and a second minor section which are arranged in the direction opposite the first direction; wherein
the first sub-pixel set and the second sub-pixel set are adjacent to each other.

6. The display apparatus as claimed in claim 5, wherein the first sub-pixel set and the second sub-pixel set are arranged in an order from first to last repeatedly in each of the pixel rows.

7. The display apparatus as claimed in claim 5, wherein the second sub-pixel set and the first sub-pixel set are arranged in an order from first to last repeatedly in each of the pixel rows.

8. The display apparatus as claimed in claim 5, wherein each two adjacent first sub-pixels in the same pixel row are identical in being in a first arrangement manner, and each two adjacent second sub-pixels in the same pixel row are identical in being in a second arrangement manner, wherein the first arrangement manner is the direction in which the first major section and the first minor section are arranged, and the second arrangement manner is defined as the direction in which the second major section and the second minor section are arranged.

9. The display apparatus as claimed in claim 5, wherein the number of the first sub-pixels of the first sub-pixel set is equal to the number of the second sub-pixels of the second sub-pixel set.

10. The display apparatus as claimed in claim 9, wherein the number of the first sub-pixels of the first sub-pixel set is greater than or equal to two; and the number of the second sub-pixels of the second sub-pixel set is greater than or equal to two.

11. The display apparatus as claimed in claim 10, wherein the first sub-pixel set has three first sub-pixels, and the second sub-pixel set has three second sub-pixels; the three first sub-pixels are arranged side by side, and the three second sub-pixels are arranged side by side.

12. The display apparatus as claimed in claim 11, wherein the first major sections of the three first sub-pixels are oriented in the first direction, and the second major sections of the three second sub-pixels are oriented in the direction opposite the first direction.

13. An array display panel comprising:
a phase retarder film; and
at least two pixel rows, wherein each of the pixel rows includes:
at least one first sub-pixel set including at least one first sub-pixel, wherein the first sub-pixel has a first major section and a first minor section which are arranged in a first direction; and
at least one second sub-pixel set including at least one second sub-pixel, wherein the second sub-pixel has a second major section and a second minor section which are arranged in the direction opposite the first direction; wherein
the first sub-pixel set and the second sub-pixel set are adjacent to each other.

14. The array display panel as claimed in claim 13, wherein the first sub-pixel set and the second sub-pixel set are arranged in an order from first to last repeatedly in each of the pixel rows.

15. The array display panel as claimed in claim 13, wherein the second sub-pixel set and the first sub-pixel set are arranged in an order from first to last repeatedly in each of the pixel rows.

16. The array display panel as claimed in claim 13, wherein each two adjacent first sub-pixels in the same pixel row are identical in being in a first arrangement manner, and each two adjacent second sub-pixels in the same pixel row are identical in being in a second arrangement manner, wherein the first arrangement manner is defined as the direction in which the first major section and the first minor section are arranged, and the second arrangement manner is defined as the direction in which the second major section and the second minor section are arranged.

17. The array display panel as claimed in claim 13, wherein the number of the first sub-pixels of the first sub-pixel set is equal to the number of the second sub-pixels of the second sub-pixel set.

18. The array display panel as claimed in claim 17, wherein the number of the first sub-pixels of the first sub-pixel set is greater than or equal to two; and the number of the second sub-pixels of the second sub-pixel set is greater than or equal to two.

19. The array display panel as claimed in claim 18, wherein the first sub-pixel set has three first sub-pixels, and the second sub-pixel set has three second sub-pixels; the three first sub-pixels are arranged side by side, and the three second sub-pixels are arranged side by side.

20. The array display panel as claimed in claim 19, wherein the first major sections of the three first sub-pixels are oriented in the first direction, and the second major sections of the three second sub-pixels are oriented in the direction opposite the first direction.
